(19) United States
(12) Patent Application Publication
(10) Pub. No.: US 2002/0095417 A1
(43) Pub. Date: Jul. 18, 2002

(54) Computer implemented interactive ergonomics resource system

(76) Inventor: Stephen L. Gordon, Columbia, MD (US)

Correspondence Address: Stephen L. Gordon, 6361 Grey Sea Way, Columbia, MD, 21045, US

(21) Appl. No.: 09/760,905

(22) Filed: Jan. 17, 2001

(51) Int. Cl. G06F 7/00

(52) U.S. Cl. 707/10

(57) ABSTRACT

An expert system, usable by layman in the field of ergonomics, that provides ergonomic programs for providing, in turn, reports including those covering controls for actual or potential work-site specific, ergonomic related hazard exposures and injuries, as well as other related reports. The system includes a web-server as well as the Internet and associated connecting devices, and a computer operated by a user. The web-server includes an interactive web-site and certain software that proposes certain questions to the user, which when answered, will identify the specific work-site of interest and the work-site conditions. When so identified, the web-server automatically accesses the appropriate ergonomics program. Extracted information is sent to the user in the form of one or more reports.

### FIELD OF THE INVENTION

The present invention relates to interactive computer systems, and more particularly, to a computer-implemented, interactive system for providing ergonomics and related resources.

### BACKGROUND OF THE INVENTION

The proliferation of the Internet has caused businesses and institutions to expand on, and reconsider their methods of doing business. The Internet has also greatly increased the accessibility of resources from geographically remote sites via web-sites. Web-sites are becoming more and more interactive. Conversely, being interactive allows for a great many services to be offered remotely via the Internet. Today, access to vast amounts of information, services, and products are literally a click away.

Prior to, and along side of the proliferation of the Internet is the wide-spread use of computers in businesses. Today, computers are used in nearly every industry imaginable. More functions are being performed on computers and employees are spending more time behind them. Unfortunately, employees can develop injuries caused by such work, as well as by many other repetitive tasks performed in many other kinds of work-sites. Some examples of the many other jobs with high repetitive motion injury rates are laboratory workers performing biochemical processes, meatpackers cutting meat, assembly workers repeating tasks in awkward positions, and general workers lifting and carrying moderate sized loads in improper ways. The types of injuries caused by ergonomic related tasks or repetitive motions are referred to as work-related musculoskeletal disorders (WMSDs). WMSDs now account for about one-third of all workplace related injuries, The cost to businesses is very high. These injuries are detrimental to businesses in that they result in lost productivity, reduced product quality, increased employee turnover and retraining, and increased worker's compensation premiums.

Implemented ergonomics programs designed for individual employers have been extremely successful in reducing the number of WMSDs experienced at their work-sites. As such, many insurance companies providing worker's compensation coverage offer premium reductions to those employers that establish these programs. Insurance companies also routinely perform ergonomic analyses for larger companies as a means of risk management or cost-control. However, they cannot afford to do so for all small companies. Typically, small businesses wishing to establish an ergonomics program must hire trained consultants to evaluate their work-site and create a plan to correct problems. This approach is very expensive, especially to small businesses, which do not benefit by the economy of scale.

In recognition of the relationship between ergonomic risks and resulting injuries, the Federal Occupational Safety and Health Administration (OSHA) has issued regulations to reduce WMSDs. Soon, it is expected that businesses will be required to establish ergonomics programs that meet OSHA requirements. Once established, businesses may be evaluated periodically for compliance with respect to the regulations. Noncompliance could result in penalties and fines as well as the threat of lawsuits initiated by employees who incur injuries at a work-site where the work-site does not meet the requirements of the regulations.

It can be understood that the availability of an inexpensive alternative to highly paid consultants would be of great benefit to many employers attempting to deal with these ergonomics related issues. The capabilities made possible by current technologies offered on the Internet can be made to meet the needs of employers at a significantly reduced cost. While some industries are now implementing interactive services via the Internet, there does not exist a suitable interactive site designed to allow employers to self-evaluate and analyze their work-site, teach basic ergonomics principles, and generate a comprehensive ergonomics program that will meet current and future OSHA requirements based on inputs from the employer related to the work-site.

For the purpose of describing the hereinafter described invention, an ergonomics program is generally one that complies with an OSHA standard and provides for the reduction of, and protection against, WMSDs by assessing and controlling a work-site environment, involving both employees and management. The OSHA standard has six elements or topics that include management leadership, employee participation, WMSD management, job hazard analysis, job hazard reduction and control, and training. Each of the six standard elements or topics may be the subject of a separate database within the ergonomics program. In the absence of an OSHA standard, the six elements would generally be adopted, modified or combined in an ergonomics program that would provide an informed and protective work-site environment.

Within an ergonomics program, controls are an essential and possibly the most important element. In broad terms, controls mean assessing the work-site and the employees and applying known solutions to eliminate or reduce hazards. Part of the OSHA controls include communication with, and assessment of, the employees, and gaining their cooperation in implementing the solutions. There are a number of topics, outside of those covered by the ergonomics program itself, that are useful in creating an improved work-site or otherwise reducing WMSD's. Information relating to each additional topic may constitute a separate database. These additional topics and databases are characterized as being “ancillary,” i.e., ancillary to the topics and databases forming the ergonomics programs.

The system output may be in the form of one or more reports relating to the user's work-site of interest that may, in turn, concern one or more of the six standard elements of an ergonomics program and, additionally, the system may output reports that relate to ancillary topics. The ancillary topics that are the subject of the reports may represent databases maintained by the system as well as those that are not.

### SUMMARY OF THE INVENTION

It is, therefore, an object of the present invention to provide a computer implemented, interactive ergonomics resource system.

A further object of this invention is to provide a computer implemented, interactive ergonomics resource system incorporating analytical software for report generation which yields an ergonomic evaluation and suggested work-site modifications specific to each work-site.

Another object of this invention is to provide a computer implemented, interactive ergonomics resource system, with particular structured ergonomics inputs, which instructs laymen on basic ergonomics principles and corrective measures.

Yet another object of this invention is to provide a computer implemented, interactive ergonomics resource system which provides a comprehensive ergonomics program that, if implemented as recommended by the ergonomic resource, will meet current OSHA regulations or modifications made to these OSHA regulations before or after they are released.

Another object of this invention is to provide a computer implemented, interactive ergonomics resource system, which provides an understanding of ergonomics, related medical problems, work-site environments and OSHA regulations, or modifications made thereto, in easy to understand layperson terminology.

Still another object of this invention is to provide a computer implemented, interactive ergonomics resource system that will reduce the cost of obtaining the necessary information, guidance, expertise, and other resources to produce an effective and unique ergonomics program for individual employers and their employees.

It is yet a further object of this invention to provide a computer implemented, interactive ergonomics resource system that achieves the preceding objects using the facilities and resources of the Internet.

Another object of the invention is to provide a media-borne ergonomics resource system that provides many of the benefits of a web-site, computer interactive ergonomics resource system.

Briefly, these and other objects can be achieved by a computer system which incorporates software designed to retrieve, interactively, work-site information from a user, analytical software that analyzes the work-site information retrieved, report generation software to create one or more ergonomics related reports, and various database resources with ergonomics related general information, instruction, and related resources. The ergonomics program report or reports may provide sufficient implementation and reporting guidelines to allow employers to establish high quality and OSHA standard compliant ergonomics programs for their companies. Possibly the most important report will concern controls for particular work-sites. In the case where the computer system utilizes the Internet, a modem equipped computer, an Internet Service Provider (ISP), and a remote web-server would also be incorporated, all of which would be conventional elements.

In the case where the Internet is not employed, the employer may be furnished one or more CDROM disks or other similar medium, which may contain questions for users and ergonomic controls as well as all databases necessary for all report generation. Such a disk may contain the entire ergonomics resource system. Alternatively, where one or more preliminary data collection cycles, in the form of questions and answers, have taken place outside of the system, the disk may be reduced, in terms of data, to that which pertains only to the particular employers work-site.

Additional objects, advantages and novel features of the invention will be set forth in the description which follows or may be learned by those skilled in the art through reading the disclosure of this application or practicing the invention. The objects and advantages of the invention may be achieved through the means recited in the claims herein. To achieve these stated and other objects, the present invention may be embodied and described as a computer implemented ergonomics system that, in its preferred embodiment, would employ the Internet. Generally, the preferred embodiment of the computer implemented ergonomics system of the present invention is achieved by maintaining an ergonomics system including unique ergonomics related software and databases which reside on a remotely accessible web-server. For example, the system web-server may be accessed by a remote computer, operated by a user, that may or may not be at an employer's work-site. Access may be achieved via the Internet using known methods. Included in the software is an analytical software engine that works on inputs from the user regarding the employer's work-site, whereby the inputs are answers to questions or queries put forth during the execution of the software program. The program can then generate one or more ergonomics reports which address the specific needs of the employer regarding ergonomics related problems, and further, addresses each problem in a manner which is geared to provide a solution that meets OSHA regulatory requirements. Also included in the system is the ability to access various ergonomics related or ancillary databases and documents, which include both those resident on the web-server or a related network, as well as those found at other sites on the Internet. Databases and documents not found on the system are accessed by activating a given hyperlink on the system's world wide web (WWW) home page or secondary pages. Ancillary databases may provide information in all areas of ergonomics from scientific and technical information to regulatory requirements, professional services, consumer ergonomics equipment, on-line training and more. Information is provided in a layperson format understandable to the average employer and employee.

To use the system, the employer must be a subscriber. Once the employer is a subscriber and has access to the system, the actual user of the system can be an employee or non-employee. The user may, in fact, be one who gains access to the system on behalf of a number of subscribers. The user may operate the system at places other than a particular employer's work-site.

### BRIEF DESCRIPTION OF THE DRAWINGS

The accompanying drawings illustrate the present invention and are part of the specification. Together with the following description, the drawings demonstrate and explain the principles of the present invention.

FIG. 1 is an simplified illustration of the network architecture of the preferred embodiment of the invention.

FIG. 2 is a flow diagram depicting the various resources of the present invention.

FIG. 3 is a flow diagram depicting the process used by the analytical software of the present invention,

### DETAILED DESCRIPTION OF TH PREFERRED EMBODIMENTS

With reference to the drawings, wherein like reference characters indicate like elements throughout the several figures, the preferred embodiment of the present invention will now be explained.

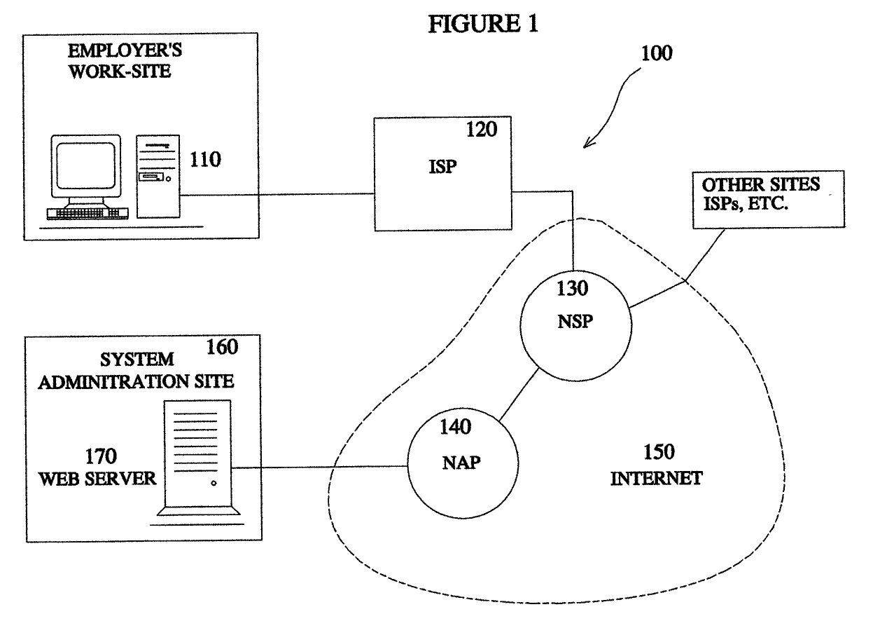

FIG. 1 illustrates the basic elements of the network architecture necessary to effectuate the computer implemented, interactive ergonomics resource system via the Internet. More specifically, the depicted network architecture 100, is a simplified diagram showing the primary resources used to access online resources of various types by means of the Internet. Network Architecture 100 includes a computer or terminal, hereafter referred to as Computer 110, an internet service provider (ISP) 120, a network service provider (NSP) 130, a network access point (NAP) 140, the Internet 150, and a system administration site (SAS) 160. It should be understood that although the Internet 150 is identified herein, for reference purposes, apart from NSP 130 and NAP 140, the actual Internet is a combination of many NSPs and NAPs, and, conceptually, may include the ISPs as well.

Computer 110 requires a communication device to connect with Internet 150. Typically, the communication device is a modem or network card. The communication device connects Computer 110, either directly or through a local area network (LAN) or wide area network (WAN), to the ISP 120, by means of a Local Loop Carrier (LLC). LLCs include traditional telephone services, i.e., the Plain Old Telephone Services (POTS), cable services, Digital Subscriber Lines (DSL), satellite, cellular, and other transmission means. The user's access is accepted and authenticated at ISP 120. ISP 120 also consolidates the data from multiple LLCs into a packet switched communication channel which is then routed to a Network Service Provider (NSP) 130. NSPs interconnect large packet switched networks at Network Access Points (NAP) 140. These large networks, NSPs, NAPs, and ISPs, are what generally define the Internet. SAS 160 is the site at which online content originates. SAS 160 maintains a web server 170 which contains the software programs and data files used in the present invention, as well as the communication means to connect with the Internet. It should be obvious to those skilled in the telecommunications art that FIG. 1 is a highly simplified version of the many systems and configurations of systems which are used to interconnect system users to online content as well as to other users around the world.

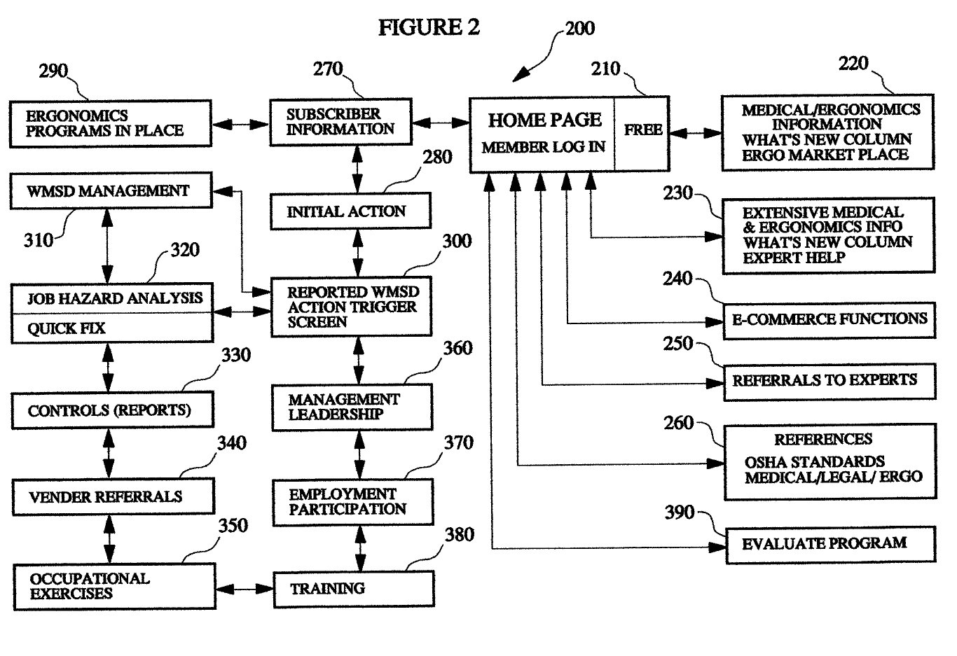

Referring now to FIG. 2, a flow diagram of a web-site incorporated into a system 200 is depicted. Each numbered block represents on-line content which is either on the system 200 web-site, or accessed from the system 200 web-site via hyperlinks. The term hyperlink refers to the many known methods used to embed world wide web addresses in a web-page document to allow a user to connect with and retrieve other web-pages on the site or at other Internet sites. Typically, a hyperlink is executed by mouse clicking on hypertext, a labeled graphic, or digitized photograph. The on-line content, which is described with respect to any individual block in FIG. 2, may be displayed on a single web-page or a group of web-pages. That is to say, a depicted block does not necessarily mean that the content is contained within a single web-page. Information, instruction, and interactive functions delivered from system 200, whether it be on a single web-page or multiple web-pages, will hereinafter be referred to simply as “content” or by its content.

The blocks in FIG. 2 represent the system of the present invention, which is based on current OSHA regulations concerning ergonomics. These can be found in 29 CFR Part 1910, subpart W, titled, “Ergonomics Program Standard.” The proposed regulations stipulate that up to six standard elements be implemented in all ergonomics programs. Each standard element addresses different requirements of the ergonomics program such as injury reporting, employee participation, training, job hazard analysis, and the like. While each of the OSHA standard elements are incorporated into the system of the present invention, the regulations may be modified. Nevertheless, these standard elements or straightforward modifications of the elements would still be utilized in the system of the present invention. It is clear that this system has significant value absent the existence of regulations.

System 200 of the present invention is comprised of many web-pages, each of which provide different ergonomics related resources. The software programs and data which create web-site 200 are executed from web-server 170 of FIG. 1. Block 210 represents the web-site home-page which contains general information related to the site, log-in username and password fields for subscribers, as well as hyperlinks to other web-sites and to unrestricted site resources. The subscribers to the system are the companies or organizations which have gained full access to the system through payment of fees or other means. The unrestricted site resources identified in block 220 are free and accessible to anyone visiting the site and are accessed via hyperlinks from block 210. The remaining blocks represent restricted site resources which require access validation, and may only be accessed after proper username and password have been furnished. A client of the system, most often an employer, must first become a subscriber of the system to receive a valid username and password.

Block 220 content contains general information related to ergonomics which may include scientific, economic, legal, and technical information, and may include hyperlinks to a database of related articles and term definitions as well as external links to other ergonomics related web-sites. Also included in block 220 is a “What's New Column”, which reports timely information regarding both ergonomics issues and timely information regarding the system 200 web-site. All information that is resident on web-server 170 and then electronically delivered to the user will be presented in a user-friendly, layperson format. Again, the term ‘user’ is employed herein to mean generally any individual who has been authorized by the subscriber to access and utilize the restricted site resources of the system 200 web-site. Furthermore, it should be understood that a layperson, as the term pertains to the present invention, is someone with either no prior training or no substantial prior training in ergonomics or OSHA standards.

Block 230 content contains information which is more comprehensive and detailed then that found in block 220. A user can easily access information at any point in the process of using the site resources and then return to the same place in the process after reviewing the information desired. Also included in block 230 is information for obtaining expert help which includes resources such as phone numbers and e-mail addresses for contacting technical support and OSHA regulation compliance assistance personnel, as well as access to chat room services. The chat rooms allow a user to join real-time discussions on ergonomics issues with experts in the ergonomics, medical, and legal professions. Block 240 content has e-commerce functions such as bill payment options and resources to allow a subscriber or user to pay subscription fees or check on account status. Block 250 content contains lists of experts in ergonomics and related fields. Users who seek or desire more expert help than that which is accessible on the system 200 web-site can search these lists to find the experts they require. Block 260 content contains links to important references such as OSHA standards which may include specific regulations with simplified, layperson explanations of the regulations, important medical findings, and legal judgments.

Block 270 represents content which has input fields to be either filled in, or, alternatively, multiple choice selections to be selected by the user, which relate to general information about the subscriber. This information includes demographic concerns such as the work-site location, the number of employees, employee status, e. g., full time or part time, the type of business, and prior or current incidences of WMSD's. Organizational information such as the types of activities performed or job classifications at the work-site, the number of employees performing each type of activity, the supervisory structure, and an indication of ergonomics programs already in place at the work-site, is to be submitted by the user as well. Where possible, drop down windows are provided so that the subscriber can simply select the correct response to the various questions. The information provided by the user is analyzed by an analytical software component resident in web-server 170 to determine the proper questionnaire to be filled out by the user concerning job hazard analysis for the work-site. The goal is to completely avoid human intervention, whenever possible, in the question-answer cycles, by the use of software. An important function of the question-answer cycles within block 270 is to identify the user's specific work-site(s) of interest so that a more detailed assessment, via additional questions and responses, can be performed. The work-site(s) of interest may have already lead to a WMSD or be at high risk by the nature of tasks performed for leading to a WMSD. Using the expert-hosted chat room feature or the system's e-mail resources, problems that cannot be solved by extensive broad solution algorithms will be resolved on a case-by-case basis.

Block 280 content provides the initial action information that must be provided by all General Industry employers (excludes agriculture, maritime, and construction) to their employees. General information to be provided includes WMSD descriptions and hazards, reporting of the signs and symptoms of WMSDs, and a summary of the OSHA standards. This allows employers and employees to understand and properly report medical problems at their work-site as required under OSHA standards.

Block 290 defines all of the issues that need to be addressed to determine if an existing ergonomics program in the workplace satisfies the OSHA standard or can be upgraded to be made compliant. An interactive question and answer session will gather the appropriate information from the employer to make this determination and prepare documentation to support this position.

Block 300 content contains information on what to do if an employee reports a WMSD or the signs or symptoms of a WMSD. The first step will be a series of questions the employer answers to assure that the employee has experienced an WMSD incident. If such a WMSD has occurred in that job, then it must be determined if the employee's job routinely involves exposure to one or more relevant risk factors. The subscribing employer will be asked a series of questions derived from OSHA's Basic Screening Tool to determine if there is a relationship, a so-called “Action Trigger,” between the job and the presence of the WMSD. If this Action Trigger is not met, then no further action is required regarding this job. If the Action Trigger is met, then the employer must satisfactorily comply with a quick fix option or develop and implement an ergonomics program with six major elements (management leadership, employee participation, WMSD management, job hazard analysis, job hazard reduction and control, and training).

Block 310 contains the information to guide the employer to provide OSHA compliant management of an employee's WMSD. Two of the major components are appropriately interacting with health care providers and providing temporary work restrictions. The user will be guided, step-by-step, to assure procedures are followed correctly.

Block 320 has two major components. These are a Quick Fix and a complete job hazard analysis. Based on an assessment of the number of reported WMSDs, eligible employers will be directed to consider a Quick Fix. The Quick Fix requires a subset of the six standard elements be implemented. Some of the required activities include gathering job task information, providing remedies to eliminate hazards, and assessing the results. All of these steps will be guided by interactive exchanges between the system 200 web-site and the subscribing employer. If the employer is not eligible for a Quick Fix, then the complete six element ergonomics program must be established. A major component of this program establishment will be a complete job hazard analysis. The analyses of ergonomic job hazards in Block 320 are the first steps to determine solutions or controls for these hazards.

Block 330 content represents the report of necessary controls generated in response to the job hazard analysis performed in block 320. The report is generated by an analytical software component executed on web-server 170. The analytical software uses an algorithm based on the responses to the block 320 questionnaires. For instance, if it was determined via a block 270 question, in an initial questionnaire, that an employee's tasks involve entering keyboard data most often greater than four hours a day, then analytical software would respond by providing a specific questionnaire related to such typing or keyboard data entry work activities in block 320. An employer subscribing to this ergonomic resource system may have more than one type of job task that can be subjected to a detailed analysis by more than one questionnaire in block 320. Once all the necessary information concerning the employee's specific work-site conditions has been provided, the system will then generate one or more block 330 reports. All reports are automatically prepared by the computer at the system administration site by simply analyzing the user's responses to the block 320 detailed questions. The report may be limited to appropriate controls or it may include other elements of a work-site specific ergonomics program.

Block 360 contains Management Leadership information as required in the OSHA standard Here, the roles of management are explained, such as how to assign and communicate the responsibilities to management staff. Also discussed are the resources and training available to meet these responsibilities. Communication with employees concerning the importance of their ergonomics program is stressed as well. Block 370 addresses Employee Participation. Here, general methods of allowing employees to participate in establishing and implementing their company ergonomics program are defined. The employer is provided detailed forms and guidance from the web-site to implement the required communications with employees.

Block 380 content focuses on training for employees and management. Structured general educational information on WMSD hazards is provided including what types of behavior causes specific WMSDs, as well as what may be the resulting signs and symptoms. Also included is an overview of the company's ergonomic program, implementation plan, training schedule, identification of trainees, and frequency of training in accordance with the company's ergonomics program. Part of the training provided is instruction regarding on-the-job, occupational exercises, which may help reduce injuries and aid in the recovery from existing injuries. Employees can quickly reference information on exercises geared to injuries associated with the employees' specific tasks, with such information including diagrams and textural instruction. Occupational exercises may also be considered a component of the report defining job controls.

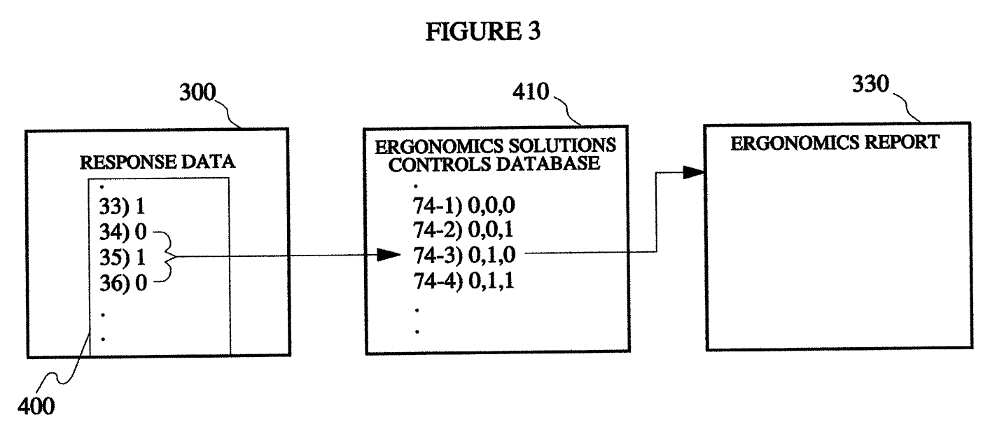

FIG. 3 illustrates the analytical software process by which the block 330 ergonomics controls report is generated. As previously discussed, a job task specific questionnaire is provided in block 320. Block 400 represents the response data which is captured by the computer. Where the report concerns ergonomic controls only, response data determines which ergonomic controls will be retrieved from an ergonomic controls database 410, the database that contains controls for all work-sites covered by the system. Again, the controls are one of the six standard elements of the OSHA ergonomics program.

Referring again to the FIG. 3 example, one of the ergonomic controls for the specific job task being assessed may be, for example, workers vertical eye position in relation to the computer monitor hazards. This control is generally shown with a prefix 74 in database 410. Database 410 is shown with a number of related controls providing solutions to vertical eye position, monitor hazards. The particular control selected will be based upon responses to questions 34, 35 and 36 in a block 300 questionnaire. In this example, control 74 may be guidance in the form of a series of possible variations with respect to the adjustment of the worker's physical position with respect to the monitor. A “yes” response to a block 300 question may be assigned a value of 1 and “no” a value of 0. As shown in block 400, the response to question 34 is “no”, the response to question 35 is “yes”, and the response to question 36 is “no,” The analytical software now stores the [0,1,0] response and matches it with the corresponding control (74-3) in database 410, the database that contains the controls for all work-sites covered by the system. This control along with all the other recommended controls are retrieved from database 410 and input into the block 330 ergonomics report. Block 330, in essence, performs a formatting function where the report is organized into an easily understood and logically organized document.

The controls in database 410 may include engineering, administrative or work practices. Engineering controls include a change, modification or redesign of workstations, tools, equipment, and the like, thereby changing the physical environment to better fit the worker. Administrative controls relate to changing the job assignment or scheduling to reduce the frequency, magnitude or duration of ergonomic risk factors. Work practices are the manner in which the task is performed within the physical environment of the work-site. One example is the proper adjustment of office furniture and training the employee on proper body positions so that the upper body extremity is maintained in a more neutral or less stressful position while typing.

Once again referring to FIG. 2, the block 330 report also has a feature that provides the employer with information on venders that can supply equipment which may be necessary to correct a work-site deficiency. Block 340 content contains the vender referrals. The vender referrals are associated with specific controls in database 410 and can be retrieved from the block 330 report via hyperlinks. Where applicable, further hyperlinks in the block 340 content can link the employer with the vender's web site.

Block 390 content reminds the employer of the need to reassess its ergonomics program at regular intervals or when work-site conditions change, and guides it through the process. To alert the employer that a reassessment is necessary, a reminder is sent from system 200 to the subscriber via email.

At this point it should be apparent that the strategy employed in the present invention allows those without skills and training in ergonomics to effectively use the disclosed system to obtain and successfully employ the ergonomic programs suggested by the system while, at the same time, also providing a valuable tool for ergonomics professionals.

Note that the present invention is not limited to the above embodiments and includes modifications within the scope of the claims.

While the invention has been described with reference to the specific embodiment chosen for the purpose of illustration, it should be apparent that numerous modifications could be made thereto by those skilled in the art without departing from the basic concept and scope of the invention.

What I claim is:

1. An ergonomics resource system comprising:
an interactive web-site including certain ergonomics resources, said resources including at least one ergonomics program that includes, in turn, at least one database;
a computer remote from said web-site;
access means for interactively connecting said web-site and said remote computer; and,
means to provide at least one report related to said ergonomics resources.

2. The ergonomics resource system of claim 1 wherein:
said ergonomics resource system is an expert system usable by laymen;
said at least one database includes controls for at least one work-site;
said remote computer may be operated by a user of said system;
said report, observable at said remote computer, includes controls for said at least one work-site.

3. A computerized ergonomics resource system comprising:
an interactive web-site including certain ergonomics resources, said resources including a plurality of ergonomics programs that include, in turn, at least one database for a plurality of specific work-sites;
a computer remote from said web-site that may be operated by a user of said system;
access means for interactively connecting said web-site and said remote computer;
means contained within said web-site for proposing certain questions to a user, obtaining answers thereto from a user, and analyzing said answers for certain ergonomics related information, all to define a work-site of interest;
means for extracting a specific ergonomics program from said database related to said work-site of interest; and,
means for making said extracted ergonomics program available to a user in the form of one or more reports.

4. The computerized ergonomics resource system of claim 3 wherein said one or more reports includes a report with specific controls related to said work-site of interest.

5. The computerized ergonomics resource system of claim 4 wherein said system is an expert system and said report may be understood and said ergonomics program implemented, by laymen in the field of ergonomics.

6. The computerized ergonomics resource system of claim 3 wherein said means for proposing questions, obtaining answers, analyzing answers and said extracting means is application software, said questions appear at a monitor associated with said remote computer, and said answers are made with use of said monitor.

7. The computerized ergonomics resource system of claim 3 wherein said ergonomics resources include at least one database in addition to any databases associated with said ergonomics programs.

8. The computerized ergonomics resource system of claim 3 wherein a user may access at least one database not maintained by said system.

9. The computerized ergonomics resource system of claim 3 wherein a user may access to at least one ancillary data base.

10. The computerized ergonomics resource system of claim 3 wherein said system is an expert system useful to laymen in the field of ergonomics.

11. The computerized ergonomics resource system of claim 3 wherein said ergonomics programs conform to government regulations.

12. A media-borne ergonomics resource system including:
ergonomics resources embedded in a storage media, said resources including at least one ergonomics program for a work-site of interest, which, in turn, includes at least one database relating said work-site of interest;
a computer with means for interfacing with said media, downloading said ergonomics resources, and extracting said at least one database for said work-site of interest.

13. The media-borne ergonomics resource system of claim 12 wherein said extracted database may be made available in the form of a report.

14. The media-borne ergonomics resource system of claim 12 wherein said at least one ergonomics program is a plurality of ergonomics programs and said at least one database is a plurality of databases.

15. The media-borne ergonomics resource system of claim 12 wherein said at least one ergonomics program is one ergonomics program.

16. The media-borne ergonomics resource system of claim 12 wherein said system is an expert system and said at least one program may be understood and implemented by laymen in the field of ergonomics.

17. The media-borne ergonomics resource system of claim 12 wherein said at least one ergonomics program conforms to government regulations.

18. The media-borne ergonomics resource system of claim 14 wherein said plurality of databases includes at least one ancillary database.

19. An ergonomics resource system comprising:
an interactive web-site including certain ergonomics resources, said resources including one or more ergonomics programs;
said web-site further including means for proposing certain questions to a user, obtaining answers thereto from a user, and analyzing said answers for certain ergonomics related information to define a work-site of interest;
means for extracting a specific ergonomics program related to said work-site of interest; and,
means for making at least a portion of said extracted ergonomics program available to a user in the form of one or more reports.

20. The ergonomics resource system of claim 19 wherein said system is an expert system useable by laymen in the field of ergonomics.

21. The ergonomics resource system of claim 19 wherein each ergonomics program has one or more databases.

22. A method for providing ergonomics resources to a user, comprising the steps of:
creating a knowledge base in the form of one or more databases, including at least one database relating to at least one ergonomics program;
eliciting information from a user sufficient to define a work-site of interest;
employing said defined work-site of interest to determine an applicable, specific ergonomics program for said work-site of interest; and,
providing access to at least one report with at least a portion of said specific ergonomics program accessible by a user.

23. The method for providing ergonomics resources to a user of claim 22, wherein:
said knowledge base includes a plurality of databases, including a plurality of databases relating to a plurality of ergonomics programs as well as databases not relating to said ergonomics programs; and,
said elicited information is obtained through at least one question and answer cycle and analysis relating thereto, employing application software.
